(19) United States
(12) Patent Application Publication
(10) Pub. No.: US 2022/0007598 A1
(43) Pub. Date: Jan. 13, 2022

(54) SABBATH MODE FOR AN INDOOR GARDEN CENTER

(71) Applicant: Haier US Appliance Solutions, Inc., Wilmington, DE (US)

(72) Inventors: Matthew Hunter, Louisville, KY (US); Michael Goodman Schroeder, Louisville, KY (US)

(21) Appl. No.: 16/927,095

(22) Filed: Jul. 13, 2020

(51) Int. Cl. A01G 27/00; A01G 9/02; A01G 7/04

(52) U.S. Cl. CPC A01G 27/003; A01G 7/045; A01G 9/023; A01G 27/005

(57) ABSTRACT

A gardening appliance and method of operation during Jewish holidays is provided herein. The indoor gardening appliance includes a liner defining a grow chamber and a grow module rotatably mounted within the grow chamber for receiving a plurality of plant pods. A controller may be configured for determining a Jewish holiday, such as the Sabbath, and may selectively control the indoor gardening appliance according to an operation routine for the Jewish holiday.

### FIELD OF THE INVENTION

The present subject matter relates generally to systems for gardening plants indoors, and more particularly, to a system and method operating an indoor gardening appliance during Sabbath.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow. These various subsystems often initiate and run automatically to facilitate plant growth.

However, Orthodox Jewish customs require that certain traditions be maintained during designated times. For instance, the Sabbath (i.e., Shabbos or Shabbat) is set aside as a time when no work should be performed. This prohibition on work may apply not only to an observer's direct physical actions, but also to actions initiated through the observer's appliances. For instance, a user may be required to abstain from causing an appliance to change its normal pattern of operation. In other words, the user may be prohibited from actions that would result in a direct response from the appliance, such as activating a lighting system, a hydration system, or another subsystem. Nonetheless, many appliances are configured to provide this kind of direct response, e.g., in response to plant needs, sensed growing conditions, etc. Unfortunately, these actions may violate the sanctity of the Sabbath.

Accordingly, it would be useful to provide an indoor garden center addressing one or more of the above-identified issues. In particular, it would be advantageous to provide an indoor garden center or method of operation with features for Sabbath-compliant operation while ensuring the plants needs are met.

### BRIEF DESCRIPTION OF THE INVENTION

Aspects and advantages of the invention will be set forth in part in the following description, or may be apparent from the description, or may be learned through practice of the invention.

In one exemplary aspect of the present disclosure, a method of operating a gardening appliance is provided. The gardening appliance includes a liner positioned within a cabinet and defining a grow chamber, and a grow module mounted within the liner and defining a plurality of apertures for receiving one or more plant pods. The method includes determining an anticipated Sabbath condition at the gardening appliance and adjusting at least one operating parameter of the gardening appliance prior to commencement of the anticipated Sabbath condition.

In another exemplary aspect of the present disclosure, a gardening appliance is provided including a liner positioned within a cabinet and defining a grow chamber, a grow module mounted within the liner and defining a plurality of apertures for receiving one or more plant pods, a light assembly configured for illuminating the plant pods to facilitate plant growth, and a controller operably coupled to the light assembly. The controller is configured for determining an anticipated Sabbath condition at the gardening appliance and adjusting at least one operating parameter of the gardening appliance prior to commencement of the anticipated Sabbath condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a flow chart illustrating a method of operating a gardening appliance in a Sabbath mode in accordance with example embodiments of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

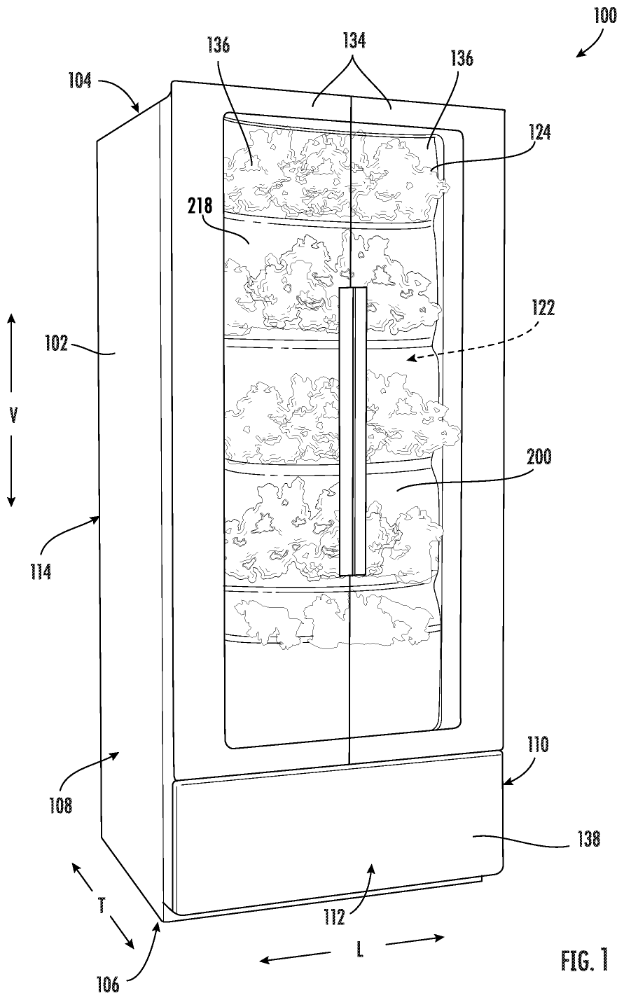

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

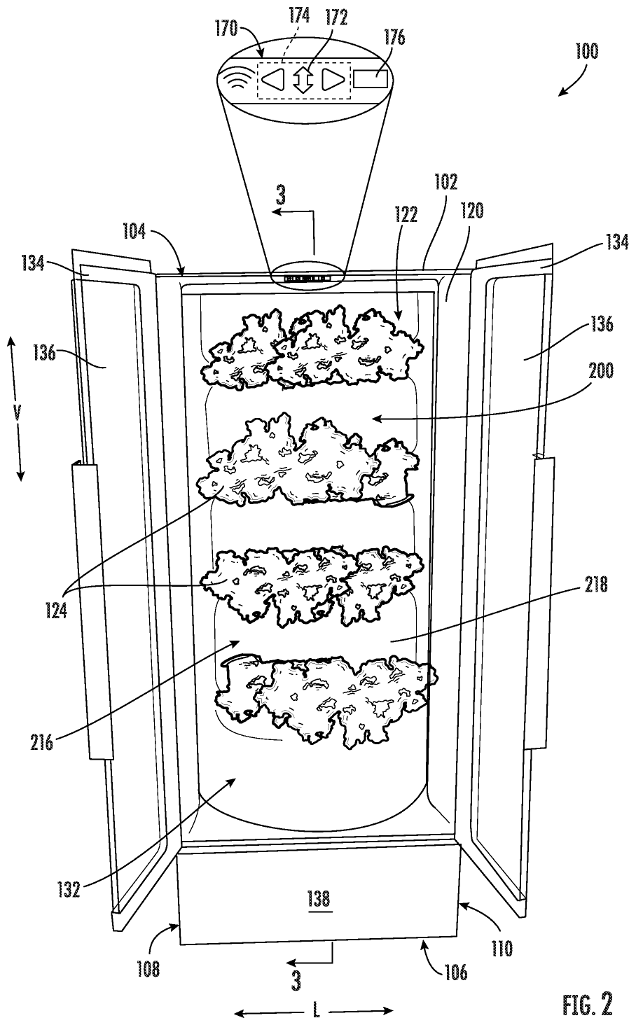

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

According to exemplary embodiments, gardening appliance 100 may include features for concealing contents of gardening appliance, e.g., by making windows 136 of doors 134 opaque, or otherwise adjusting the transparency or translucency of windows 136 to minimize visibility of plants. It should be appreciated that any suitable technology may be used to reduce visibility of the inside of gardening appliance, such as mechanical shades, covers, tinting, etc. According to an exemplary embodiment, window 136 may include a PDLC film (Polymer-Dispersed Liquid Crystal) that may be transparent when electric current is supplied to it. In this manner, when gardening appliance 100 is operating normally, e.g., during a non-Sabbath operating condition, an electric current is supplied to make windows 136 transparent. However, during a Sabbath mode of operation, the electric current may be removed, resulting in windows 136 becoming opaque. Other suitable methods of making windows 136 dark or opaque are possible and within the scope of the present subject matter.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

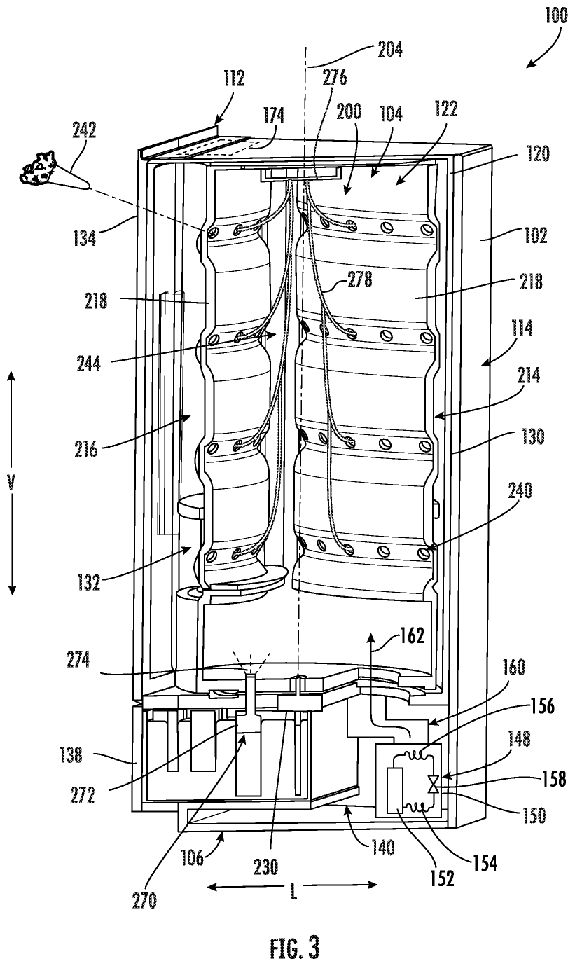

FIG. 3 provides a schematic view of certain components of an environmental control system 148 that may be used to regulate a temperature within grow chamber 122. Specifically, environmental control system 148 may include a sealed system 150, a duct system 160, and a hydration system 270, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc. According to exemplary embodiments, gardening appliance 100 may further include a ripening control system (not shown) for regulating air quality characteristics within grow chamber 122, e.g., by maintaining desirable gas concentrations or other flow characteristics of a flow of air.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Moreover, controller 174 may include multiple cycles or modes of operation (e.g., a Sabbath mode and a non-Sabbath mode) that control or regulate various portions of gardening appliance 100 according to one or more discrete criteria. In other words, controller 174 may be configured to control gardening appliance 100 differently for a non-Sabbath mode than in a Sabbath mode. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

As noted above, controller 174 may include multiple unique cycles or modes of operation, such as a Sabbath mode (e.g., in which a Sabbath cycle is executed) and a non-Sabbath mode (e.g., in which one or more typical gardening appliance cycles, modes, or operations are executed). Moreover, controller 174 may automatically (e.g., without active user input or engagement) determine when to enter or exit each mode of operation. Moreover, controller 174 may automatically anticipate and prepare the gardening appliance 100 for a Sabbath (e.g., prior to the start of a Sabbath or Sabbath condition). Controller 174 may further adjust operation of the gardening appliance 100 upon the start of the anticipated Sabbath condition.

In some embodiments, controller 174 is configured to determine when a Sabbath condition occurs (e.g., when work-prohibiting Sabbath traditions must be followed). For instance, such determinations may be made onboard with the rest of the components of controller 174 or, alternatively, offboard, such as on a secondary controller board spaced apart from the rest of controller 174 (and in operative communication therewith). In certain embodiments, controller 174 is programmed to include a preset Jewish calendar. During installation, a user may specify the initial time. A clock module (not shown) may be provided within controller 174 to maintain a current date and time once the initial time is specified. During installation, a user may further specify a geographic location (e.g., zip code, city and state, latitude and longitude, etc.) of gardening appliance 100. Additionally, or alternatively, the geographic location may be automatically determined [e.g., by a global positioning satellite unit (not pictured) within controller 174]. Once installed, controller 174 may automatically track and determine when a Sabbath condition occurs along the Jewish calendar at the specified geographic location. For instance, controller 174 may compare the current time to the preset Jewish calendar (e.g., continuously or at a predetermined interval). In some such embodiments, controller 174 may include a communications module to receive information (e.g., from a remote server or website) regarding sunrise and sunset for the specified geographic location. Accordingly, controller 174 may transmit or receive a Sabbath condition signal to indicate exactly when the Sabbath begins or ends.

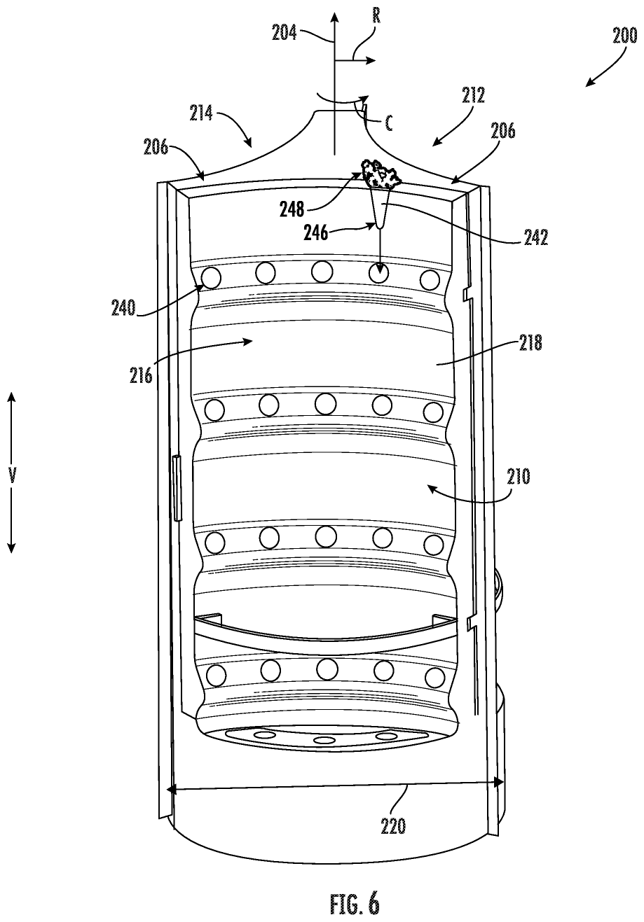

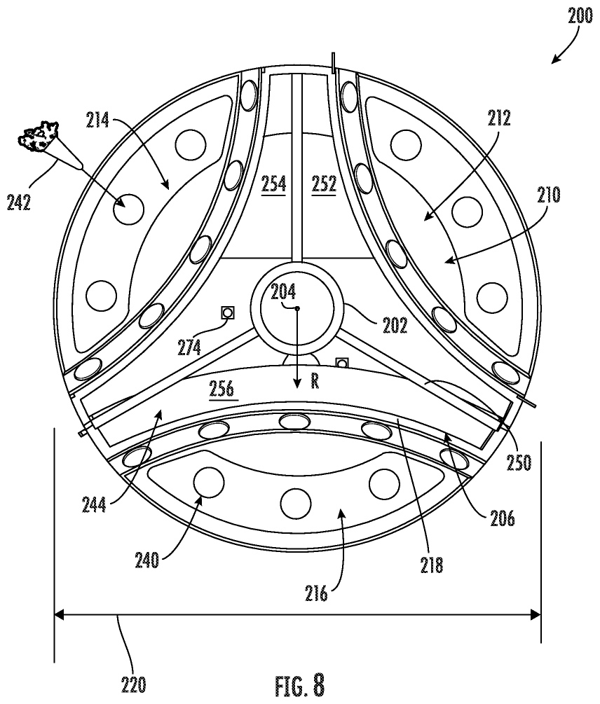

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

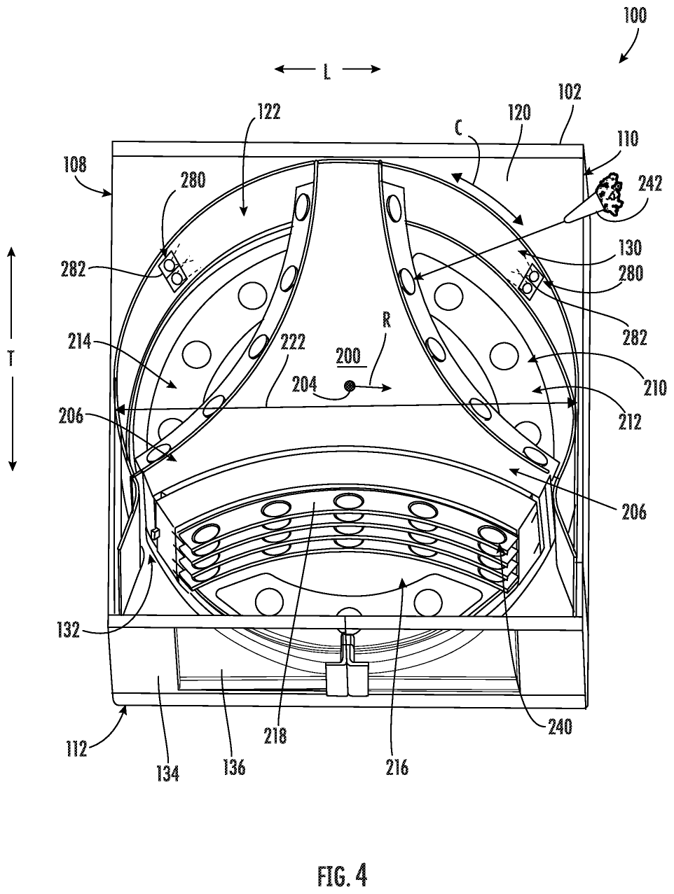

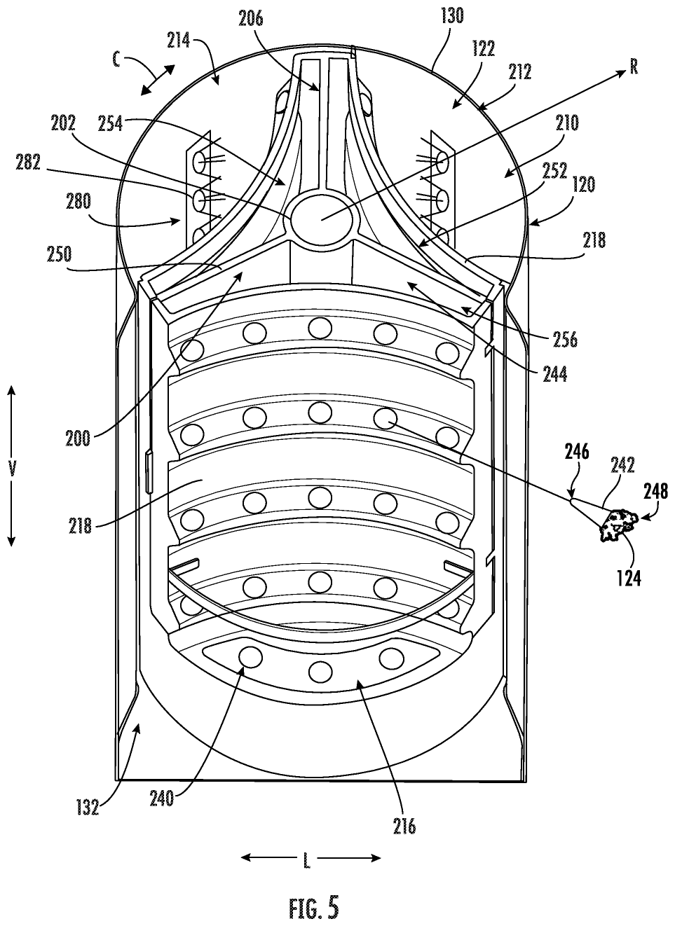

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

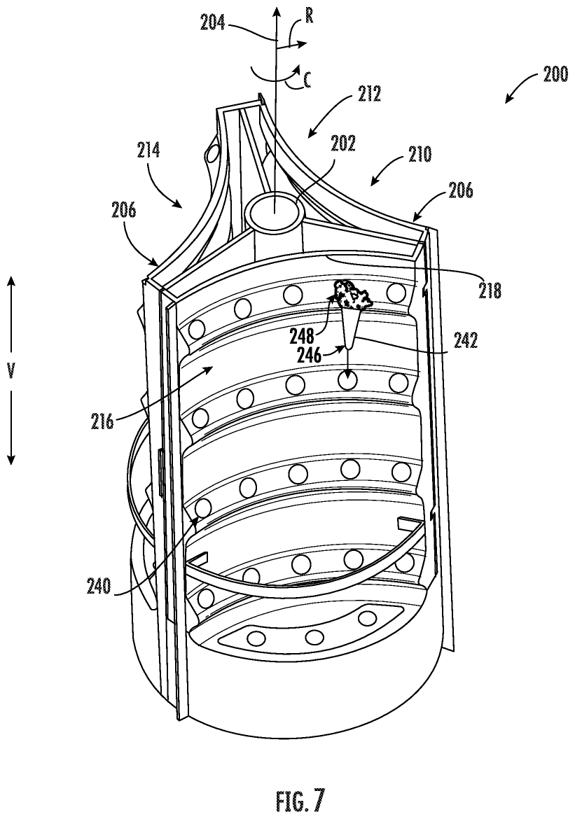

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Referring now briefly to FIG. 3, hydration system 270 may further include a system for hydrating plants 124 when gardening appliance 100 is not in a normal operating mode, e.g., such as in the event of a power loss or during a Sabbath mode of operation. In this regard, for example, hydration system 270 may include features for storing water and/or ice for hydrating plants 124 during such conditions. According to the exemplary embodiment, hydration system 270 includes a storage reservoir 276 for containing ice or water and a drip line 278 fluidly coupled to storage reservoir 276. In this regard, for example, drip line 278 may include a plurality of tubes that provide fluid from storage reservoir 276 to plants 124. According to exemplary embodiments, drip line 278 may include various restrictions for ensuring a slow and steady drip of water onto each plant 124.

During normal operation, or in anticipation of a power outage or Sabbath mode, hydration system 270, environmental control system 148, and other subsystems may operate to fill storage reservoir 276 with water or ice. In this regard, for example, ice may be formed by using hydration system 270 to fill storage reservoir 276 with water and then using sealed system 150 to chill or freeze the water. When the Sabbath condition begins and the hydration system 270 is shut off, the drip line may be configured for slowly hydrating plants 124 stored in grow module 200, e.g., during the anticipated Sabbath condition.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

As explained above, light generated from light assembly 280 may result in light pollution within a room where gardening appliance 100 is located. Therefore, aspects of the present subject matter are directed to features for reducing light pollution, or to the blocking of light from light sources 282 through front display opening 132. Specifically, as illustrated, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

Now that the construction of gardening appliance 100 has been described, an exemplary method 400 of operating a gardening appliance will be described. Although the discussion below refers to the exemplary method 400 of operating gardening appliance 100, one skilled in the art will appreciate that the exemplary method 400 is applicable to the operation of a variety of other gardening appliances or for use in any suitable application. In exemplary embodiments, the various method steps as disclosed herein may be performed by controller 174 or a separate, dedicated controller. As explained below, method 400 is generally directed to operating a gardening appliance, such as gardening appliance 100, according to a Sabbath mode or cycle for effective or efficient performance while ensuring adherence to Jewish law.

Generally, the present disclosure provides an appliance, such as a gardening appliance, and a method of operating the appliance during Sabbath. The appliance may automatically determine when Sabbath occurs based on a specific geographic location. Moreover, the appliance may automatically enter and remain in a Sabbath mode during Sabbath. The Sabbath mode may prevent a user from performing any work without having to mentally consider when the Sabbath begins and/or ends. This may occur while still maintaining a suitable growth environment for the plants. Although the Sabbath is used herein as an exemplary religious holiday to explain operation of gardening appliance 100 during such a religious holiday, it should be appreciated that aspects of the present subject matter may be used to regulate operation of gardening appliance 100 during other religious holidays or during any other suitable time period.

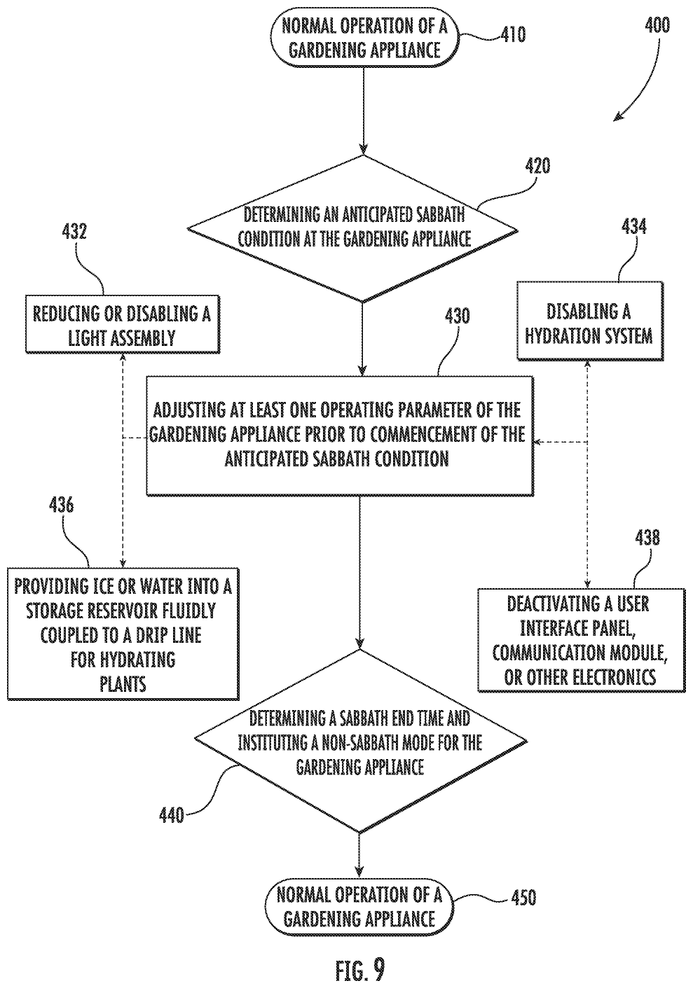

Referring now to FIG. 9, method 400 includes, at step 410, operating a gardening appliance 100 in a standard or normal operating mode. In this regard, the normal operating mode may refer operation of gardening appliance 100 outside of, or not during, the Sabbath. For example, during normal operating mode, gardening appliance 100 and all of its subsystems (e.g., environmental control system 148, hydration system 270, light assembly 280, and other subsystems) may all operate normally to facilitate healthy growth of plants 124.

Method 400 further includes, at step 420, determining an anticipated Sabbath condition (e.g., an upcoming Sabbath according to Jewish law) at a gardening appliance. Specifically, 420 includes determining that a Sabbath (i.e., designated religious holiday or period of religiously-required rest) will soon begin. Optionally, 420 may be performed prior to the actual start of the anticipated Sabbath condition. For instance, 420 may be performed at a predetermined amount of time (e.g., greater than or equal to 24 hours) prior to the start of the anticipated Sabbath. Thus, step 420 may include determining the anticipated Sabbath will start within the predetermined time (e.g., in a day's time). In other words, step 420 may include determining the predetermined time until the start of the Sabbath condition. In such embodiments, the gardening appliance may begin preparing for the Sabbath condition before the Sabbath actually starts (e.g., starting at the predetermined time, such as at least 24 hours in advance).

Step 430 includes adjusting at least one operating parameter of the gardening appliance prior to commencement of the anticipated Sabbath condition. Step 430 may also include operating gardening appliance 100 during the Sabbath condition to ensure the health of plants 124 without violating Sabbath law. As used herein, an “operating parameter” of gardening appliance 100 is any cycle setting, operating time, compressor speed, fan speed, part configuration, or other operating characteristic that may affect the performance of gardening appliance 100. Thus, references to operating parameter adjustments or “adjusting at least one operating parameter” are intended to refer to control actions intended to affect system performance to meet the plant's needs while honoring the Sabbath. For example, adjusting an operating parameter may include shutting down or adjusting the operation of an environmental control system 148, sealed system 150, hydration system 270, and/or light assembly 280. Other operating parameter adjustments are possible and within the scope of the present subject matter.

During the Sabbath, method 400 includes directing gardening appliance 100 to operate in a Sabbath-compliant state (e.g., until the anticipated Sabbath condition expires). The parameters of the Sabbath-compliant state may be programed by the manufacturer, set by the user, or determined and set in any other suitable manner. For example, FIG. 9 illustrates several exemplary operating parameter changes that may be used according to exemplary embodiments of the present subject matter. For example, step 432 includes reducing or disabling a light assembly of the gardening appliance. In this regard, for example, light assembly 280 may cease operation according to a standard illumination schedule and may begin operation according to a Sabbath mode lighting schedule. Depending on an observer's particular beliefs and/or the particular religious holiday being practiced or observed, the Sabbath mode lighting schedule may include completely shutting off light assembly 280, lowering light levels, or only operating light assembly 280 at particular times for particular durations.

Similarly, step 434 may include disabling a hydration system of the gardening appliance. In this regard, any pumps or pressurized water sources that would otherwise hydrate plants 124 may stop operation altogether. Notably, if plants 124 do not receive any hydration for the entire Sabbath period, withering or death may occur. Therefore, gardening appliance 100 may include features for maintaining at least minimal levels of the hydration for plants 124 even when hydration system 270 is operating in the Sabbath mode. In this regard, for example, step 436 includes providing ice or water into a storage reservoir fluidly coupled to a drip line for hydrating plants. Specifically, gardening appliance 100 may provide water and/or ice into storage reservoir 276 during normal operation. Alternatively, a user of gardening appliance 100 may supply ice in anticipation of the Sabbath. This stored water and/or ice may pass through drip line 278 when hydration system 270 is disabled to maintain suitable hydration for plants 124. For example, during normal operation, hydration system 270 may fill storage reservoir 276 with water and sealed system 150 may cool or chill the water to form ice. In this manner, when hydration system 270 and sealed system 150 are turned off, the ice may slowly melt and the resulting water may pass through drip line 278 onto plants 124.

According to still other embodiments, hydration system 270 may initiate a soak operation just prior to commencement of the anticipated Sabbath condition. In this regard, hydration system 270 may begin soaking plants 124 with an excessive amount of water at a certain time before the commencement of the Sabbath mode. For example, 5 or 10 minutes before the Sabbath begins, hydration system 270 can provide large amounts of water (e.g., two or three times the water provided under the normal hydration schedule) onto plants. In this manner, plants 124 may be able to survive for a longer period of time during the Sabbath without requiring additional hydration.

According to exemplary embodiments, step 438 further includes deactivating a user interface panel, a communication module, a sealed system, or other parts or subsystems of gardening appliance 100. In this regard, user interface panel or control panel 170 may reduce or eliminate communications to user, may minimize requested inputs, or may otherwise alter its operation to facilitate Sabbath observance. According still another embodiment, controller 174 may adjust the translucency of door 134. In this regard, as described above, controller 174 may cut electricity to a PDLC film on window 136 to make window 136 opaque or otherwise limit visibility through window 136.

Following the start of the anticipated Sabbath condition, controller 174 may track or record the elapsed time for the Sabbath condition to detect if/when the Sabbath is over. Specifically, step 440 may include determining a Sabbath end time in instituting a non-Sabbath mode for the gardening appliance at the determined Sabbath end time. In this regard, once it is determined that the Sabbath has started, an inactivity timer may be initiated to count the time that passes after the start time of the Sabbath. For instance, the inactivity timer may track the time for which the Sabbath condition has been present relative to a maximum time period (e.g., measured in hours, such as 24 hours) programmed with the inactivity timer. Thus, upon expiration of the Sabbath or Sabbath condition (e.g., at a determined Sabbath end time), the method 400 may initiate a non-Sabbath mode, e.g., by initiating normal operation of the gardening appliance at step 450. Alternatively, the non-Sabbath mode may include any other operating cycles or parameters, such as operating cycles for addressing conditions generated during the Sabbath. For example, plants 124 may be deprived of water, so controller 174 may initiate another soak operation using hydration system 270, may use hydration system 270 to refill storage reservoir 276, may manipulate light assembly 180 to boost grow lighting, etc.

FIG. 9 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 400 are explained using gardening appliance 100 as an example, it should be appreciated that these methods may be applied to the operation of any suitable gardening appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a gardening appliance, the gardening appliance comprising a liner positioned within a cabinet and defining a grow chamber, and a grow module mounted within the liner and defining a plurality of apertures for receiving one or more plant pods, the method comprising:
determining an anticipated Sabbath condition at the gardening appliance; and
adjusting at least one operating parameter of the gardening appliance prior to commencement of the anticipated Sabbath condition.

2. The method of claim 1, wherein determining the anticipated Sabbath condition comprises:
determining a predetermined time until the anticipated Sabbath condition commences.

3. The method of claim 2, wherein the predetermined time is 24 hours or greater.

4. The method of claim 1, wherein adjusting at least one operating parameter of the gardening appliance prior to commencement of the anticipated Sabbath condition comprises:
reducing or disabling a light assembly of the gardening appliance.

5. The method of claim 1, wherein adjusting at least one operating parameter of the gardening appliance prior to commencement of the anticipated Sabbath condition comprises:
disabling a hydration system of the gardening appliance.

6. The method of claim 1, wherein the gardening appliance comprises:
a storage reservoir for containing ice or water; and
a drip line fluidly coupled to the storage reservoir, the drip line being configured for hydrating plants stored in the grow module during the anticipated Sabbath condition.

7. The method of claim 6, wherein adjusting at least one operating parameter of the gardening appliance prior to commencement of the anticipated Sabbath condition comprises:
providing ice in the storage reservoir positioned above the grow module.

8. The method of claim 7, wherein providing ice in the storage reservoir comprises:
receiving water from a hydration system; and
operating a sealed system to freeze the water and form the ice.

9. The method of claim 6, wherein adjusting at least one operating parameter of the gardening appliance prior to commencement of the anticipated Sabbath condition comprises:
filling the storage reservoir with water prior to commencement of the anticipated Sabbath condition.

10. The method of claim 1, wherein adjusting at least one operating parameter of the gardening appliance prior to commencement of the anticipated Sabbath condition comprises:
initiating a soak operation just prior to commencement of the anticipated Sabbath condition.

11. The method of claim 1, wherein adjusting at least one operating parameter of the gardening appliance prior to commencement of the anticipated Sabbath condition comprises:
disabling a sealed system of the gardening appliance.

12. The method of claim 1, wherein adjusting at least one operating parameter of the gardening appliance prior to commencement of the anticipated Sabbath condition comprises:
adjusting the translucency of a door of the gardening appliance.

13. The method of claim 1, wherein adjusting at least one operating parameter of the gardening appliance prior to commencement of the anticipated Sabbath condition comprises:
deactivating a user interface panel prior to commencement of the anticipated Sabbath condition.

14. The method of claim 1, wherein adjusting at least one operating parameter of the gardening appliance prior to commencement of the anticipated Sabbath condition comprises:
disabling a communication module for receiving external updates or disabling notification.

15. The method of claim 1, further comprising:
determining a Sabbath end time; and
instituting a non-Sabbath mode for the gardening appliance automatically upon reaching the determined Sabbath end time.

16. A gardening appliance, comprising:
a liner positioned within a cabinet and defining a grow chamber;
a grow module mounted within the liner and defining a plurality of apertures for receiving one or more plant pods;
a light assembly configured for illuminating the plant pods to facilitate plant growth; and
a controller operably coupled to the light assembly, the controller being configured for:
determining an anticipated Sabbath condition at the gardening appliance; and
adjusting at least one operating parameter of the gardening appliance prior to commencement of the anticipated Sabbath condition.

17. The gardening appliance of claim 16, wherein adjusting at least one operating parameter of the gardening appliance prior to commencement of the anticipated Sabbath condition comprises:
reducing or disabling the light assembly of the gardening appliance.

18. The gardening appliance of claim 16, further comprising:
a hydration system configured for providing water to plants to support their growth, wherein adjusting at least one operating parameter of the gardening appliance prior to commencement of the anticipated Sabbath condition comprises disabling the hydration system of the gardening appliance.

19. The gardening appliance of claim 16, further comprising:
a storage reservoir for containing ice or water; and
a drip line fluidly coupled to the storage reservoir, the drip line being configured for hydrating plants stored in the grow module during the anticipated Sabbath condition.

20. The gardening appliance of claim 19, wherein adjusting at least one operating parameter of the gardening appliance prior to commencement of the anticipated Sabbath condition comprises:
providing ice or water into the storage reservoir positioned above the grow module for hydrating plants during the anticipated Sabbath condition.
